(19) United States
(12) Patent Application Publication
(10) Pub. No.: US 2005/0289059 A1
(43) Pub. Date: Dec. 29, 2005

(54) Apparatus, system, and method for presenting a document image together with a manual signature

(76) Inventors: James Gabriel Brewington, Raleigh, NC (US); James D. Piette, Raleigh, NC (US); David William Stanhope, Cary, NC (US)

Correspondence Address: KUNZLER & ASSOCIATES, 8 EAST BROADWAY, SUITE 600, SALT LAKE CITY, UT, 84111, US

(21) Appl. No.: 10/878,148

(22) Filed: Jun. 28, 2004

(51) Int. Cl. G06Q 40/00

(52) U.S. Cl. 705/45

(57) ABSTRACT

An apparatus, system, and method are provided for presenting a document image together with a manual signature. The document image is of a traditionally paper-based transaction document such as a check. The invention includes an imager, a display device, and a controller. The imager generates a document image from a physical document. The display device displays the document image to a user. The controller associates a manual signature generated by the user with the displayed document image. An electronic representation of the manual signature may be generated using a digitizer in communication with the controller. Preferably, the components of the invention are implemented using multipurpose devices such as a touch-screen display, printer/scanner, and the like.

### BACKGROUND OF THE INVENTION

1. Field of the Invention

The invention relates to document image systems. Specifically, the invention relates to apparatus, systems, and methods for presenting a document image together with a manual signature.

2. Description of the Related Art

Computer technology continues to influence how business is conducted around the world. Generally, computer systems are most popular in business processes that developed directly from the capabilities of the computer systems. For example, because of technologies such as web servers, servlets, web applications, web services, E-commerce processes such as Business to Business (B2B) and Business to Consumer (B2C) processes have emerged. Generally, any new technology, and in particular computer technology, is very slow to replace more traditional business transactions such as execution of contracts and other agreements and financial transactions.

Computer technology, however, continues to make headway in replacing conventional paper-based transactions with faster, more efficient, and more reliable electronic processes for completing the same business transactions including agreements. Today, contract negotiations may be conducted via email or video teleconferencing. Contracts, in many jurisdictions, can be entered and legally enforced by use of digital signatures, a form of encryption. The digital signature is typically completely unrelated to a person's actual manual signature. However, some, both young and old, place more confidence and trust in the traditional processes that may include face-to-face meetings and signing of paper documents.

One new form of electronic transaction that has met with resistance from customers is Electronic Check Conversion (ECC). Retailers and merchants view ECC very favorably because processing of an actual paper check is not required. This saves the retailer time and money because the labor intensive paper check handling process performed by the retailer, the retailer's bank, and the consumer's bank is removed. However, customers who are being encouraged to use ECC have resisted the change. The present invention improves the ECC process by making it easier and more intuitive for customers to transition to the new ECC process which enables retailers to benefit from significant cost savings.

The ECC process begins by a retailer accepting a check from a customer. The check, which is typically blank, is passed through a reader that reads the Magnetic Ink Character Recognition (MICR) information from the check. The MICR information generally includes the bank routing number, customer account number, and check serial number. This is all the information needed to execute an automated clearing house transaction that debits the customer's account via electronic communications.

Before the ECC process is initiated, a user must provide written authorization by signing an agreement acknowledging that the payment will be made through the ECC process. Typically, this agreement is printed on the backside of the check or on a piece of receipt size paper. The agreement is presented to a customer for a manual signature. The agreement may also include the amount of the purchase, the payee, and acknowledgement and authorization for debiting of fees should the user's account not contain sufficient funds.

Once the manual signature is provided, the ECC process can be initiated. The ECC process is an electronic process which withdraws funds from the customer's account and deposits them in the retailer's account. Typically, the retailer voids and returns the check to the user along with a receipt for the purchase. The retailer generally retains the authorization slip for future reference. Optionally, the retailer may print details of the transaction such as the amount, date, and payee on the check before the check is voided and returned.

FIG. 1 illustrates a system 100 of conventional equipment that may be used to complete an ECC transaction. The system 100 includes at least a printer 102 and a Point-of-Sale (POS) register 104. The printer 102 typically includes a scanner 106 and a MICR reader 108. As mentioned, the MICR reader 108 reads the magnetic ink line of a check to determine MICR information. Typically, the scanner 106 is used to generate a check image of the front-side of the check and optionally the backside as well. The check image is used to collect funds at a later time if the ECC transaction is returned and automated attempts to collect funds fail. The check image may also be used in combination with Optical Character Recognition (OCR) techniques to read or confirm the MICR code read by the MICR reader 108.

The POS register 104 generally controls the printer 102 and comprises a general purpose computer running POS software. The POS software interfaces with the printer to print receipts, ECC authorization, void a check, and collect information from checks including MICR information, check images, and the like. Together, the POS register 104 and printer 102 can initiate an ECC transaction.

Generally, the POS register 104 also interfaces with a display 110. The display 110 presents information about the transaction to a user such as a customer. The display 110 indicates the amount of the purchase and may provide an itemized list of the items purchased.

In certain systems 100, the display 110 comprises a multi-function device that facilitates a variety of payment transactions available to the customer. For example, the display 110 may include a card reader 112, a touch-screen display 114, a keypad 116, and a stylus 118. The purpose and function of each of these components 112, 114, 116, 118 is well known and will not be described further. Using these components 112, 114, 116, 118 a user/customer can provide payment using a debit card, credit card, cash card, or the like.

It is well known to use the stylus 118 to provide a manual signature to authorize an electronic transaction such as a credit/debit card transaction. The user may provide a manual signature directly on the touch-screen display 114. Alternatively, or in addition, the display 110 may include a signature pad (not shown) that captures a manual signature. Typically, text displayed on the screen summarizes the transaction and presents a line for a user's signature to indicate authorization.

It has also been proposed that the touch-screen display 114 be used to present a computer drawn generic check 120 to a user/customer. The generic check 120 may comprise a drawing of lines and text configured to look like a traditional check. The MICR reader 108 may read MICR information from a user's check. The generic check 120 could include MICR information displayed in the same position as on the user's physical check. In addition, the generic check 120 could include transaction information such as the date, amount, and payee. The user may be asked to provide a manual signature on a signature line of the generic check 120 positioned in the vicinity of signature lines on actual checks.

Unfortunately, these payment methods have met with limited success. As mentioned above, people are generally resistant to change proven processes such as manually signing agreements and other legal documents in favor of new computer related technology. This is particularly true when the transaction involves the user's own money. People are typically very cautious about how money changes hands in a transaction.

These people are often highly skeptical of electronic payment processes which purport to eliminate tried and true methods such as cash payment or payment by a check. It is well known that a check constitutes a directive to the user's bank to pay the stated amount, to the stated payee. For some users, even though new technology such as ECC is less expensive, more efficient, and safer, the saying “seeing is believing” holds true. These users would often rather incur the delay and expense of writing a paper check so that the user's confidence that the transaction will complete properly is maintained. In addition to seeing and using a customer's own paper check, customers may be reluctant to use ECC due to the increased risk of electronic transactions to computer fraud, hacking, and identity theft.

Accordingly, a need exists for a method, apparatus, and system to present a document image together with a manual signature. The apparatus, system, and method should allow the user to see an image of his/her actual paper document being used in the electronic transaction so as to elicit confidence and trust from the users. In addition, the apparatus, system, and method should facilitate electronic transactions by allowing a manual signature combined with a digital image of the document to serve as authorization for the electronic transaction. Further the apparatus, system, and method should store a copy of the digital image of the document and a representation of the manual signature for use later by a merchant or user if needed.

### BRIEF SUMMARY OF THE INVENTION

The present invention has been developed in response to the present state of the art, and in particular, in response to the problems and needs in the art that have not yet been met for presenting a document image together with a manual signature. Accordingly, the present invention has been developed to provide an apparatus, system, and method for presenting a document image together with a manual signature that overcomes many or all of the above-discussed shortcomings in the art.

An apparatus according to the present invention includes an imager, a display device, and a controller. The imager generates a document image from a physical document. The imager may comprise a digital scanner, digital camera, or the like. The display device displays the document image to a user. The display device may comprise any electrical display device. The controller associates a manual signature generated by the user with the displayed document image. The controller preferably communicates with the imager and display device. In one embodiment, the controller communicates with a digitizer configured to convert a manual signature into an electronic representation of the signature. The controller may present the document image and the electronic representation of the signature to a user in the display device.

In certain embodiments, the controller associates the document image with a manual signature by overlaying the document image with the electronic representation coo of the signature. Alternatively or in addition, the controller overlays the document image with transaction-specific information. The apparatus may also comprise a storage module configured to store the document image and an electronic representation of the manual signature. The apparatus may optionally include a confirmation module configured to confirm the accuracy of pre-printed information of the physical document displayed in the document image and collect accurate information for use in place of inaccurate pre-printed information. The apparatus may further include an authentication module configured to augment the pre-printed information in the document image with authentication information provided by the user.

The apparatus may include a combiner that modifies the document image to include an electronic representation of the manual signature. Of course, the controller may associate the document image and electronic representation in various other ways including assigning a common identifier to both the document image and the electronic representation, displaying the document image and electronic representation in close physical proximity, and the like. The apparatus may also include a reception module configured to receive the physical document from the user and present the physical document to the imager.

A method of the present invention is also presented for presenting a document image together with a manual signature. In one embodiment, the method includes generating a document image from a physical document. Next, the document image is displayed to a user. Finally, in one embodiment, the document image is overlaid with an electronic representation of a manual signature generated by the user. Optionally, the method may also include receiving the physical document from the user and associating the document image with the electronic representation of the manual signature.

The present invention includes a system for presenting a document image together with a manual signature. The system includes a document feeder configured to receive a physical document, an imager configured to generate a document image from the physical document received by the feeder, a display device in communication with the imager and configured to display the document image to a user, a controller in communication with the display device and configured to overlay the document image with an electronic representation of a manual signature provided by the user, a printer coupled to the document feeder and configured to print the electronic representation of the manual signature and transaction-specific information on the physical document, and a digitizer configured to generate the electronic representation of the manual signature.

The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is block diagram illustrating a conventional prior art apparatus for conducting an electronic transaction using a physical document;

FIG. 2 is a logical block diagram illustrating one embodiment of an apparatus in accordance with the present invention;

FIG. 3 is a block diagram illustrating one embodiment of a system in accordance with the present invention;

FIG. 4 is a block diagram illustrating one embodiment of an apparatus in accordance with the present invention;

FIG. 5 is a block diagram illustrating a one embodiment of transaction information presented with a document image to a user in accordance with the present invention; and

FIG. 6 is a schematic flow chart diagram illustrating a method of the present invention for presenting a document image together with a manual signature.

### DETAILED DESCRIPTION OF THE INVENTION

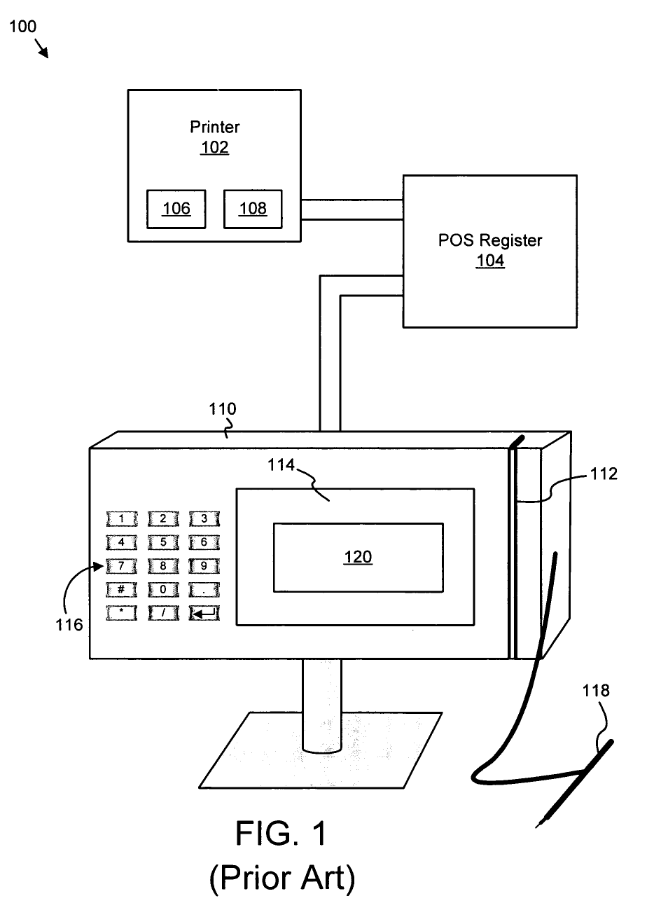

It will be readily understood that the components of the present invention, as generally described and illustrated in the figures herein, may be arranged and designed in a wide variety of different configurations. Thus, the following more detailed description of the embodiments of the apparatus, system, and method of the present invention, as presented in FIGS. 1 through 6, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, function, or other construct. Nevertheless, the con executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of programming, software modules, user selections, user interfaces, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

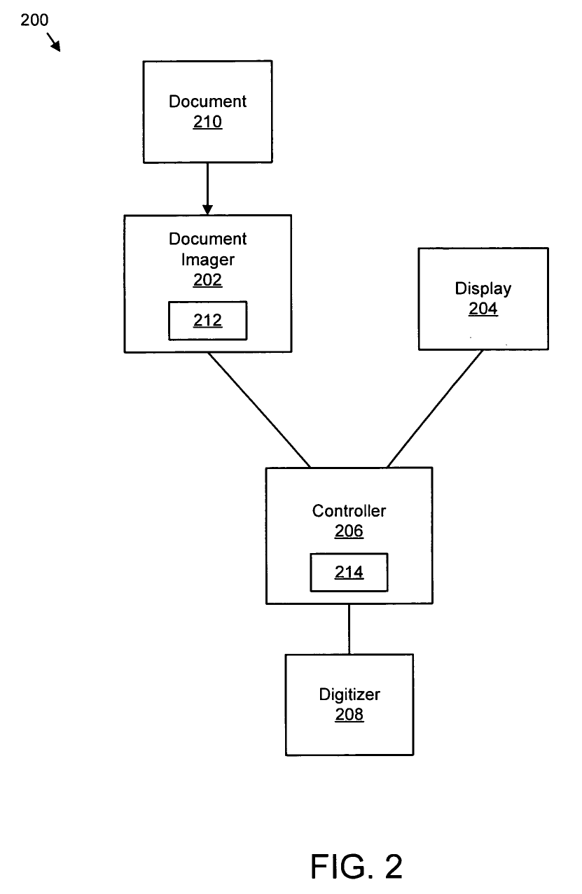

FIG. 2 illustrates a logical block diagram of an apparatus 200 for presenting a document image together with a manual signature. The apparatus 200 includes a document imager 202, display 204, controller 206, and digitizer 208. The devices 202, 204, 206, 208 comprise logical representations of various actual devices which may implement the functionality of these logical devices 202, 204, 206, 208. The apparatus 200 associates a physical document 210 with a manual signature generated by a user such that user confidence is increased. The user sees both a document image and an electronic representation of the manual signature such that the user may be confident that any electronic transaction based on the document 210 and authorized by the manual signature is safe, reliable, and trustworthy.

The document imager 202 comprises any device capable of generating a document image from the physical document 210. The physical document 210 may comprise one or more pages. Accordingly, the document image produced by the document imager 202 may comprise a digital image of the front and back sides of each page of the physical document 210. Alternatively, the document image(s) may comprise a digital image of the front side of the document 210.

The document imager 202 may comprise a digital scanner, a digital camera, or an analog image capture device coupled to a converter configured to convert the analog image to a digital image. The document imager 202 may comprise a stand-alone device or be integrated with another device such as a printer. In addition, the document imager 202 may capture the document image in color, black and white, or various shades of grey in a grey scale.

The display 204 comprises any device capable of displaying the document image generated by the document imager 202. The display 204 may display the document image in color, black and white, or various scales of grey. Preferably, the display 204 is configured to display other information in addition to the document image. In one embodiment, different items may be displayed by overlaying one displayed item over another in a layered approach in which lowered layers are selectively visible through upper layers. The display 204 may be integrated with other devices such as a touch-screen to provide a touch screen display.

The controller 206 interacts with the document imager 202, display 204, and digitizer 208 to associate a manual signature with a displayed document image. There are a variety of associations the controller 206 may make between the manual signature and the document image. In one embodiment, the document image is displayed in close physical proximity to (above or below) a pad upon which a user generates a physical signature. The close physical proximity may be such that the user notices and recognizes the document image while generating the manual signature.

The digitizer 208 is a device configured to convert an analog input such as signing of a manual signature into an electronic representation of the manual signature. Digitizers 208 are well known. Typically, the electronic representation comprises a graphics bitmap representing where the stylus makes contact with the digitizer 208 within a predefined field. Typically, analog information is entered into a digitizer 208 using a stylus, though other devices such as a user's finger may also be used. In the present invention, the digitizer 208 communicates with the controller 206 such that the controller 206 may associate the electronic representation of the manual signature with the document image.

In one embodiment, the document image may be displayed while a user signs the actual physical document. Signature of the actual physical document may be understood by the user as authorization to use the document image or other information from the document in an electronic transaction. In another embodiment, the controller 206 overlays a document image displayed on the display 204 with an electronic representation of a manual signature. The electronic representation may be overlaid in real-time as the manual signature is generated or after a user generates a satisfactory electronic representation of the user's signature.

Operation of the apparatus 200 begins with presentment of a document 210 by a user. A reception module 212 of the document imager 202 may receive the document 210 and present the physical document 210 to the imager 202. The reception module 212 may comprise an automatic sheet feeder capable of feeding one or more physical pages of a physical document 210 to the imager 202. Alternatively, the reception module 212 may comprise a location in front of a lens of the imager 202.

The imager 202 generates a document image that may be provided to the display 204 through the controller 206. The display 204 displays the document image to a user. Simultaneously, the digitizer 208 is prepared to receive a manual signature generated by the user. Preferably, the electronic representation of the manual signature is provided to the controller and simultaneously presented to the user with the document image. In one embodiment, the document image is overlaid with the electronic representation.

In one embodiment, the controller includes a combiner 214 that modifies the document image to include the electronic representation of the manual signature. The modifications may be done in real-time or after the manual signature is generated. Alternatively, the electronic representation of the manual signature and the document image may be maintained separately and associated in various different ways. For example, a unique serial number may be assigned to both the document image and the electronic representation. Alternatively, both the document image and the electronic representation may be stored in a common data structure such as a two field array.

Those of skill in the art will recognize that the document imager 202, display 204, controller 206, and digitizer 208 may be used with any type of document 210 to conduct any kind of business or legal transaction. For example, the document 210 may comprise a will, a contract, a court order, piece of legislation, or the like. The electronic representation of the manual signature and the document image may be stored for auditing or archival purposes. Alternatively, the document 210 may comprise a check, a billing invoice, security agreement, or other form of financial document in which the signature of the user indicates authorization to execute the transaction represented by the document 210.

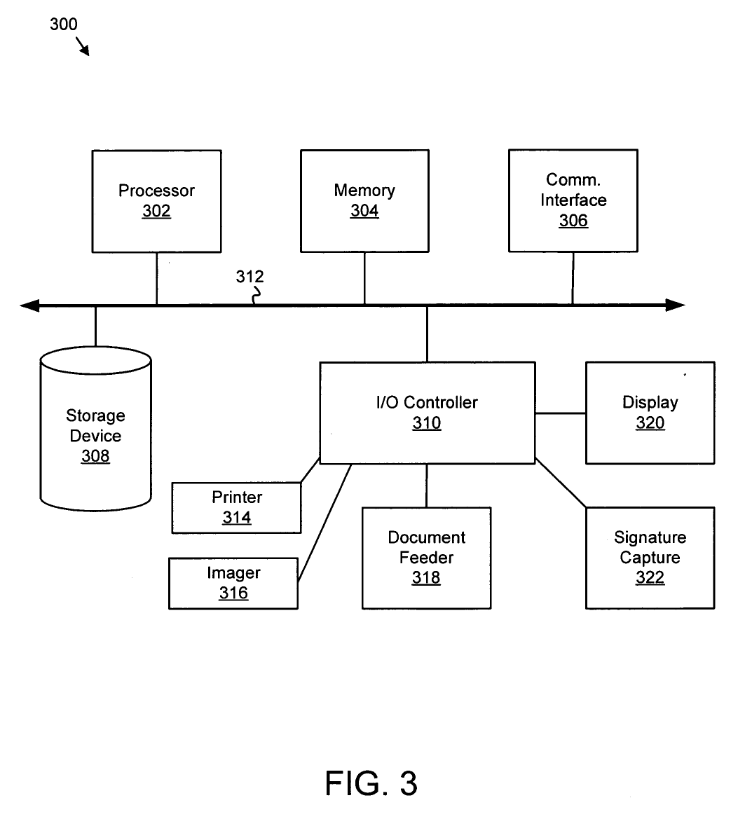

FIG. 3 illustrates a system 300 for presenting a document image together with a manual signature. The system 300 includes conventional components coupled to other components configured to implement the functionality of the logical components depicted in FIG. 2. Specifically, the system 300 includes a processor 302, a memory 304, a communication interface 306, a storage device 308, and an I/O controller 310 interconnected by a communications bus 312. These main components may comprise a single system such as a personal computer or separate components in communication with each other via the bus 312 or other communication channels.

The processor 302 is a well known component and may comprise a Central Processing Unit (CPU) or other logic unit. The memory 304 is also well known. Preferably, the memory comprises Random Access Memory (RAM). The storage device 308 comprises persistent storage such as a hard drive or the like. Of course, other well known peripherals may be connected to the bus 312 as well.

The I/O controller 310 allows the processor 302 to interact with a plurality of peripherals configured to implement the features of the present invention. The I/O controller 310 manages communication of control and data information between the peripherals and the other components such as the processor 302 connected to the bus 312.

In one embodiment, the I/O controller 310 may be coupled to a plurality of peripherals simultaneously. For example, the I/O controller 310 may comprise a Universal Serial Bus (USB 2.0) controller 310 and the peripherals may be connected in a daisy chain manner. Alternatively, each peripheral may be separately connected to the bus 312 and include its own separate controller 310.

In the illustrated embodiment, the peripherals include a printer 314, an imager 316, a document feeder 318, a display device 320, and a signature capture device 322. The document feeder 318 receives one or more pages of a physical document 210 (See FIG. 2) from a user. Without a physical document, the system 300 is unable to present a document image of the document 210 together with a manual signature. The document feeder 318 presents the document 210 to the imager 316. The imager 316 generates a document image from the document 210.

The document image is then presented by, for example, the processor 302 using the display device 320 to a user. The user then has a clear visual representation of his/her own document. With the assurance that the physical document 210 provided is also the one that will be used in the transaction, the user provides a manual signature to authenticate and authorize a transaction based on the physical document 210. The manual signature is preferably provided using the signature capture device 322.

In one embodiment, the signature capture device 322 comprises a digitizer configured to translate physical movement of a writing instrument such as a stylus or pen on the surface of the digitizer into an electronic representation of the movement. In the present invention, the movement comprises a user's signature.

The digitizer may comprise a transparent digitizer on top of the display. Alternatively, the digitizer comprises a writing pad configured to allow the user to use either a stylus or a pen (with a suitable paper slip covering the pad). In another embodiment, the user may provide a predefined electronic representation of his/her signature. For example, the user may present a persistent memory module such as a memory stick on which the electronic representation is stored. In this example, the signature capture device 322 may include a memory card reader for retrieving the electronic representation.

The electronic representation of the user's signature may be stored in memory 304 and made available to the processor 302. The processor 302 preferably operates software in memory 304 to perform the functions of the controller 206 discussed above in relation to FIG. 2. Specifically, the processor 302 associates the electronic representation of the manual signature with the document image being displayed in the display device 320.

Preferably, the processor 302 overlays the document image on the display 320 with the electronic representation of the manual signature. The document image may be overlaid in real-time, as the manual signature is provided, or subsequent to a user providing the manual signature. Alternatively or in addition, the processor 302 may combine the document image on the display 320 with the electronic representation by replacing pixels of the document image stored in the memory 304 with pixels of the electronic representation. This combination of the electronic representation and document image may be permanent or temporary.

The printer 314 may be used to print transaction-specific information on print media. In one embodiment, the printer 314 and electronic representation of the manual signature may be used to print the manual signature and/or transaction-specific information on the physical document 210 provided by the user. Alternatively or in addition, the printer 314 may print information on the physical document 210 or another print media indicating acknowledgement of the transaction authorized and/or consummated by the manual signature provided. For example, where the physical document 210 is a check, the printer 314 may acknowledge the completed transaction by printing “VOID” on the face of the check.

The storage device 308 may store the electronic representation of the manual signature as well as the document image together or separately. The electronic representation and document image may be stored for archival or auditing purposes.

The communications interface 306 enables the system 300 to communicate with other servers and/or computer systems to initiate an electronic transaction. In certain embodiments, the manual signature authorizes an electronic transaction involving information from the physical document 210. For example, an ECC transaction may be initiated by the communications interface 306 when a check is the physical document 210. The communications interface 306 may send information from the check to an automated clearing house for an electronic finds debit transaction.

In other embodiments, providing the manual signature may complete the business or financial transaction. In these embodiments, the communications interface 306 may be used to send original copies of the document image and electronic representation of the manual signature to the parties involved in the transaction. For example, copies may be sent to the user, an attorney, a bank, an electronic deposit box, a third-party beneficiary, and the like. The copies may be sent in digital format using any communication media such as email or the like.

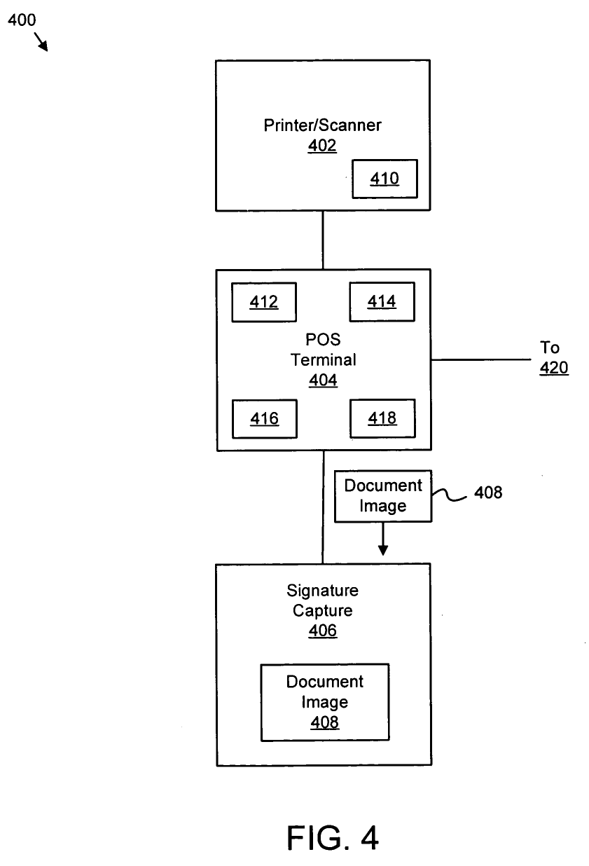

FIG. 4 illustrates an apparatus 400 for presenting a document image together with a manual signature. The apparatus 400 is configured to present document con images from a specific type of document, for example, checks. Because the apparatus 400 is configured for specific physical documents, certain system components described in relation to FIG. 3 are combined such that the physical components of this apparatus 400 perform multiple functions.

The apparatus 400 may include a printer/scanner 402, a POS terminal 404, and a signature capture device 406. The printer/scanner 402 is configured to print on either side of a physical document and generate a document image that includes at least the face of the physical document. In certain embodiments, the printer/scanner 402 generates two document images, one for each side of the document.

A printer (not shown) within the printer/scanner 402 may print on the physical document information related to a transaction. A scanner (not shown) within the printer/scanner 402 may generate the document image(s). The scanner may generate the document image(s) in color, black and white, or various levels of grey in a grey scale. A magnetic ink reader (not shown) in the printer/scanner 402 may read the MICR information on a check. With the MICR information, the POS terminal 404 is able to initiate an ECC transaction.

The POS terminal 404 serves as a controller controlling the printer/scanner 402 and signature capture device 406 in order to complete a transaction such as a sales transaction. The POS terminal 404 implements substantially the same features as the controller 206 discussed in relation to FIG. 2. In particular, the POS terminal 404 dynamically overlays the document image 408 with an electronic representation of a manual signature as the manual signature is generated by the user. This dynamic overlaying of the document image fosters consumer confidence that the transaction they are authorizing with the signature is safe, secure, and using the physical instrument (the physical document) that the user expects.

The POS terminal 404 may comprise a general purpose computer executing POS software, a client terminal, an electronic cash register, or other retail device capable of interfacing with the printer/scanner 402 and signature capture device 406 to complete a transaction. The POS terminal 404 sends a document image 408 received from the printer/scanner 402 to the signature capture device 406.

The signature capture device 406 displays the document image 408 to a user. In addition, the signature capture device 406 captures an electronic representation of a manual signature generated by the user. Preferably, the signature capture device 406 comprises an integrated display (color or black and white) and transparent digitizer, for example, a touch-screen display. The touch-screen display 406 may enable a user to generate a manual signature directly over the top of the document. The manual signature may be hand-written over a place on the document image corresponding to the proper place for such a signature on the physical document. Of course, the signature capture device 406 may provide other well known functions such as displaying screens, menus, and buttons of a user interface and receiving other user input in addition to a manual signature.

In certain embodiments, the printer/scanner 402 includes a reception module 410 similar in function to the reception module 212 discussed above in relation to FIG. 2. Consequently, the reception module 212 includes well known gears, motors, document guides and the like for receiving various sizes of physical documents such as checks.

In another embodiment, the POS terminal 404 includes a combiner 412, a storage module 414, an authentication module 416, and a confirmation module 418. The combiner 412 enables the POS terminal 404 to associate the electronic representation of the manual signature with the document image 408. Once the electronic representation of the manual signature is associated with the document image 408, the POS terminal 404 may initiate a transaction such as an ECC transaction by sending transaction-specific information, described in greater detail below, to another system 420 such as an automated clearing house for an electronic funds debit transaction.

The association provided by the combiner 412 may take various forms. In one embodiment, the combiner 412 modifies the document image 408 such that pixels of the document image are changed to represent the electronic representation of the manual signature. This modification may be done during or after generation of the signature. Alternatively, the combiner 412 may assign a common identifier to the document image 408 and the electronic representation. In yet another alternative, the combiner 412 may place the document image 408 and the electronic representation in a common data structure.

The storage module 414 stores the document image 408 and the electronic representation in whichever format the combiner 412 generates. The storage module 414 stores the document image 408 and the electronic representation to a persistent storage medium such as a hard drive or tape. In addition, the storage module 414 may send a copy of the document image and the electronic representation to a remote location for storage and/or backup.

The authentication module 416 collects authentication information about the user to ensure that the user presenting the physical document is in fact the owner of the physical document with proper authorization to conduct the transaction. This authentication information may include identifying information such as a driver's license number, a social security number, a telephone number, and the like. The authentication module 416 may collect the authentication information using a series of input screens and other interface components displayed on the display of the signature capture device 406.

The confirmation module 418 confirms the accuracy of pre-printed information on the document image 408. Pre-printed information for a check, for example, may include information such as a user's name, address, phone number, bank name, bank address, check number, and MICR information, which includes the routing number and bank account number. Information such as a user's address, name, or phone number may be different at the time the transaction is being executed. Consequently, the confirmation module 418 may allow a user to enter accurate information to be used in place of inaccurate information on the physical document that is being displayed in the document image 408. The confirmation module 418 may confirm the accuracy of pre-printed information and collect any accurate information using a series of input screens and other interface components displayed on the display of the signature capture device 406.

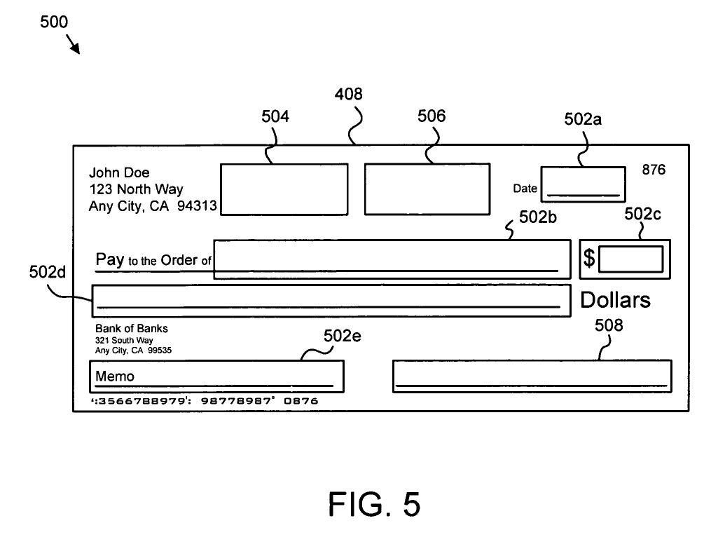

FIG. 5 illustrates a user interface 500 in which the POS terminal 404 (See FIG. 4), or another controller 404, uses the document image 408. The POS terminal 404 communicates with the signature capture device 406 to use the document image 408 as part of an interface that presents the document image 408 and the electronic representation of the manual signature, authenticates the user, and confirms pre-printed information on the physical document.

The interface 500 may include multiple transparent layers. Alternatively, the display may alter the document image 408 in order to present certain information. Preferably, each layer of the interface 500 manages different information. First, the POS terminal 404 may overlay the document image 408 with transaction-specific information.

Transaction-specific information is information relevant to executing the transaction. Transaction-specific information may be computer generated, user entered, or pre-printed. For a sales transaction, transaction-specific information may include the date, amount in both numeric and text format, and the payee. This transaction-specific information is overlaid on the document image 408 in substantially the same position as the information would normally be placed on the physical document.

Fields 502a-e of the interface 500 may hold the transaction-specific information. The user may edit the fields 502a-e if they are incorrect or unacceptable. For example, a user may want to change the amount of the check in order to get cash back from the retailer. Or, the user may wish to fill in the memo field 502e to further identify the transaction. The user may also post-date the check using the date field 502a. Entries may be made in the fields 502a-e using a keyboard or keypad (not shown) or by hand using the digitizer of the signature capture device 406. In this manner, the user works with a document image 408 of his/her own check and customizes the transaction-specific information as desired.

In one embodiment, the physical document presented by the user is a blank check including pre-printed information and blank fields to be filled in as the check is being used. Pre-printed information includes information such as a user's name, address, phone number, bank name, bank address, check number, and MICR information, which includes the routing number and bank account number.

The interface 500 may include a confirmation field 504 that cooperates with the confirmation module 418 (See FIG. 4) for collection of accurate information. A user may be prompted to input accurate information into the confirmation field 504 to replace inaccurate pre-printed information. For example, a user may enter an address or phone number different from that included on the document image 408. In this manner inaccuracies in the physical document may be adjusted as necessary.

The interface 500 may also include an authentication field 506 that cooperates with the authentication module 416 (See FIG. 4) to collect authentication information. The transaction-specific information may be augmented by authentication information to facilitate detection and prevention of fraudulent transactions.

A user may be prompted to input authentication information into the confirmation field 504. Alternatively, the authentication information may be input using for example a machine reader that reads a driver's license magnetic strip. Note that the authentication field 506 is positioned in the same location over the document image 408 where authentication information is traditionally written on the physical document. This further assures a user that the transaction about to be initiated is safe and reliable. In certain embodiments, the authentication field 506 is editable. In this manner, authentication information may be collected and adjusted as necessary.

Of course, the interface 500 also includes a signature field 508. The user preferably generates his/her signature by signing over the top of the document image 408 at or near a line on the physical document for the signature. As described above, the signature is captured with a digitizer and preferably displayed in real time over the document image 408 as the signature is generated. The signature field 508 may be read-only or editable. If the signature field 508 is editable, a user may select the signature field 508 and re-write the signature if the first attempt was unsatisfactory.

Enabling the user to sign on top of the document image 408 from the user's own document makes the electronic transaction that will follow more realistic to the user. Consequently, users who fear technology or are more comfortable with traditional paper transaction will be more at ease because they are applying their signature in a manner much closer to actually signing the physical document when signing on the document image 408. In addition, if desired the electronic representation of the signature and other transaction-specific information may be printed on the same physical document for the convenience and peace of mind of the user.

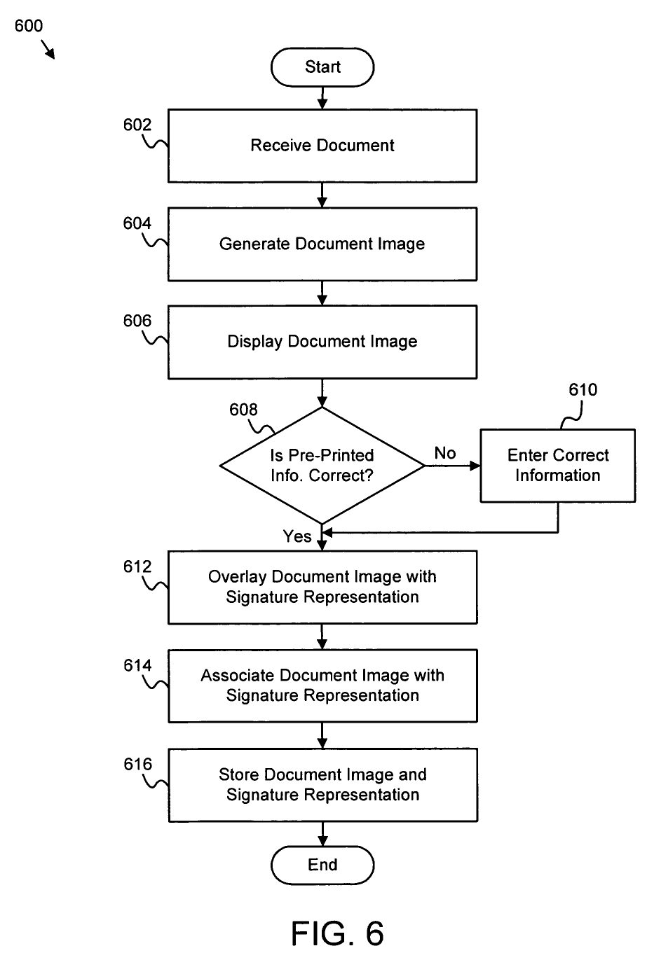

FIG. 6 illustrates a flow chart of a method 600 for presenting a document image 408 (See FIG. 4) together with a manual signature. The method 600 begins when an electronic transaction is to be initiated or consummated based on a physical document 210 (See FIG. 2).

In one embodiment, the physical document 210 is received 602, for example, by a reception module 212 of a document imager 202. Next, the document imager 202 generates 604 a document image 408 of at least the face of the document 210. Then, the document image 408 is displayed 606 to a user.

In one embodiment, a determination 608 is made whether pre-printed information on the physical document 210 is accurate. An interface or a retail POS terminal operator may prompt the user regarding the pre-printed information. If the pre-printed information is not correct, the user or an operator may enter 610 the correct information. As described above, authentication information may also optionally be collected to augment the pre-printed information and further authenticate the user.

If the pre-printed information is correct, the document image 408 is overlaid 612 with an electronic representation of a manual signature. The electronic representation may be overlaid or otherwise presented with the document image 408 as the manual signature is generated. Alternatively, the electronic representation is overlaid on top of the document image 408 after the manual signature is generated. Preferably, the electronic representation is presented in the same position as a manual signature is traditionally applied to the physical document 210.

Next, the electronic representation is associated 614 with the document image 408. This association may comprise combining the electronic representation and the document image 408 into a single bitmap image. Alternatively, the electronic representation and the document image 408 may be associated in different ways described above. Finally, the document image 408 and the electronic representation are stored 616 for future reference. In certain embodiments, the document image 408 and the electronic representation may be sent via electronic means, such as email, to the user for record keeping. Preferably, the electronic representation, transaction-specific information, and/or the document image 408 are then used to initiate an electronic transaction.

In summary, the present invention provides an apparatus, system, and method for presenting a document image together with a manual signature. The present invention allows the user to see his/her actual paper document being used in the electronic transaction so as to elicit confidence and trust from the users. The apparatus, system, and method facilitate electronic transactions by allowing a manual signature combined with a digital image of the document to serve as authorization for the electronic transaction. Furthermore, the present invention also stores a copy of the digital image of the document and a representation of the manual signature for use later by a merchant or user as needed.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. An apparatus for presenting a document image together with a manual signature, the apparatus comprising:
an imager configured to generate a document image from a physical document;
a display device configured to display the document image to a user; and
a controller configured to associate a manual signature generated by the user with the displayed document image.

2. The apparatus of claim 1, wherein the controller overlays the document image with an electronic representation of the manual signature.

3. The apparatus of claim 1, further comprising a reception module configured to receive the physical document from the user and present the physical document to the imager.

4. The apparatus of claim 1, further comprising a combiner configured to modify the document image to include an electronic representation of the manual signature.

5. The apparatus of claim 1, wherein the controller overlays the document image with transaction-specific information the apparatus further comprising a storage module configured to store the document image and an electronic representation of the manual signature.

6. The apparatus of claim 1, further comprising a confirmation module configured to confirm the accuracy of pre-printed information of the physical document displayed in the document image and collect accurate information for use in place of inaccurate pre-printed information and further comprising an authentication module configured to augment the pre-printed information in the document image with authentication information provided by the user.

7. An apparatus for presenting a document image together with a manual signature, the apparatus comprising:
a printer/scanner configured to print on a physical document and generate a document image from the physical document;
a signature capture device configured to display the document image to a user and capture an electronic representation of a manual signature generated by the user; and
a controller coupled to the printer/scanner and signature capture device, the controller configured to dynamically overlay the document image with the electronic representation of the manual signature as the manual signature is generated by the user.

8. The apparatus of claim 7, wherein the printer/scanner receives the physical document from the user.

9. The apparatus of claim 7, wherein the controller modifies the document image to include the electronic representation of the manual signature.

10. The apparatus of claim 7, wherein the controller overlays the document image with transaction-specific information.

11. The apparatus of claim 7, wherein the physical document comprises a check and wherein the printer/scanner comprises a magnetic ink reader configured to read Magnetic Ink Character Recognition (MICR) information from the check and wherein the controller initiates an electronic check conversion transaction in response to the user generating the manual signature on top of the document image of the check.

12. A system for presenting a document image together with a manual signature, the system comprising:
a document feeder configured to receive a physical document;
an imager configured to generate a document image from the physical document received by the feeder;
a display device in communication with the imager and configured to display the document image to a user;
a controller in communication with the display device and configured to overlay the document image with an electronic representation of a manual signature provided by the user; and
a printer coupled to the document feeder and configured to print the electronic representation of the manual signature and transaction-specific information on the physical document.

13. The system of claim 12, further comprising a digitizer coupled to the controller, the digitizer configured to generate the electronic representation of the manual signature.

14. The system of claim 12, further comprising a storage device configured to store the document image and the electronic representation of the manual signature.

15. The system of claim 12, further comprising a communication interface configured to initiate an electronic transaction in response to the user generating the manual signature on top of the document image of the physical document.

16. A method for presenting a document image together with a manual signature, the method comprising:
generating a document image from a physical document;
displaying the document image to a user; and
overlaying the document image with an electronic representation of a manual signature generated by the user.

17. The method of claim 16, further comprising receiving the physical document from the user.

18. The method of claim 16, further comprising associating the document image with the electronic representation of the manual signature.

19. The method of claim 18, wherein associating the document image comprises modifying the document image to include the electronic representation of the manual signature.

20. The method of claim 16, further comprising overlaying the document image with transaction-specific information.

21. The method of claim 16, further comprising confirming the accuracy of pre-printed information of the physical document displayed in the document image and collecting accurate information for use in place of inaccurate pre-printed information.

22. The method of claim 16, further comprising augmenting the pre-printed information of the physical document displayed in the document image with authentication information provided by the user.

23. The method of claim 16, further comprising storing the document image and the electronic representation of the manual signature.

24. An article of manufacture comprising a program storage medium readable by a processor and embodying one or more instructions executable by a processor to perform a method for presenting a document image together with a manual signature, the method comprising:
generating a document image from a physical document;
displaying the document image to a user; and
overlaying the document image with an electronic representation of a manual signature generated by the user.

25. The article of manufacture of claim 24, further comprising receiving the physical document from the user.

26. The article of manufacture of claim 24, further comprising associating the document image with the electronic representation of the manual signature.

27. The article of manufacture of claim 26, wherein associating the document image comprises modifying the document image to include the electronic representation of the manual signature.

28. The article of manufacture of claim 24, further comprising overlaying the document image with transaction-specific information.

29. The article of manufacture of claim 24, further comprising storing the document image and the electronic representation of the manual signature.

30. An apparatus for presenting a document image together with a manual signature, the method comprising:
means for generating a document image from a physical document;
means for displaying the document image to a user; and
means for overlaying the document image with an electronic representation of a manual signature generated by the user.
